(19) United States
(12) Patent Application Publication
(10) Pub. No.: US 2022/0006323 A1
(43) Pub. Date: Jan. 6, 2022

(54) A BI-FUNCTIONAL RECEIVING/ TRANSMITTING ELEMENT FOR WIRELESS CHARGING

(71) Applicant: HUMAVOX LTD

(72) Inventor: Asaf Manova-Elssibony Manova-Elssibony, Tel-Aviv (IL)

(21) Appl. No.: 17/291,885

(22) PCT Filed: Nov. 6, 2019
(86) PCT No.: PCT/IB2019/059551

§ 371 Date: May 6, 2021

Related U.S. Application Data
(60) Provisional application No. 62/756,273, filed on Nov. 6, 2018.

(51) Int. Cl. H02J 50/10; H02J 50/20

(52) U.S. Cl. CPC H02J 50/10; H01F 38/14; H02J 50/20

(57) ABSTRACT

The present invention provides for a wireless charging system which may function as both RF wireless charging systems and inductive wireless charging system. The bi-functional element may be configured to function as either a coil for inductive charging, or as an antenna for RF electromagnetic charging of a wireless device. Certain embodiments of the invention provide for a switch to assist in selecting the function of the bi-functional antenna. By having the ability to switch between different charging methodologies, users of rechargeable devices may charge their electrical devices by prevailing wireless charging methods available.

### CROSS-REFERENCE TO RELATED APPLICATIONS

This application claims the benefit of U.S. Provisional Application No. 62/756,273, having filing date of Nov. 6, 2018, the disclosures of which are hereby incorporated by reference in their entirety and all commonly owned.

### FIELD OF INVENTION

The present invention is in the field of wireless charging in general and in particular, it is directed to a novel bi-functional receiving/transmitting element that can be used in both magnetic induction wireless charging systems and electromagnetic (RF) wireless charging systems.

### BACKGROUND

Wireless charging systems and wireless charging devices are well known in the art. Some examples of such charging systems and devices that are using electromagnetic energy for charging are described in detail in international patent publications Nos. WO 2013/118116, WO 2013/179284, and WO 2015/022690 of the same inventor all incorporated herein by reference.

Use of receiving and transmitting antennas for electromagnetic energy transmission in well known in the art. Moreover, use of two or more coils is also well-known in the art.

It should be appreciated that rechargeable devices can be configured to be wirelessly charged through inductive methods or electromagnetic methods. However, this now requires that owners of such wirelessly rechargeable devices have access to both RF wireless charging systems and inductive wireless charging systems. Accordingly, there remains an unmet need for a wireless charging system that is configured to operate as both RF wireless charging systems and inductive wireless charging system so that users may charge their rechargeable device irrespective of the wireless charging method available.

### SUMMARY OF THE INVENTION

The present invention provides for a wireless charging system which may function as both RF wireless charging systems and inductive wireless charging system.

Aspects include one or more elements, whether a transmitting element or a receiving element, which may function as either a coil for inductive charging, or as an antenna for RF electromagnetic wireless charging of a device.

Further aspects of the invention provide for methods of switching a wireless charging system from inductive charging to RF electromagnetic charging, or vice versa.

This summary is provided to introduce a selection of concepts in a simplified form that are further described below in the Detailed Description. The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

Examples illustrative of embodiments of the disclosure are described below with reference to figures attached hereto. In the figures, identical structures, elements or parts that appear in more than one figure are generally labeled with the same numeral in all the figures in which they appear. Dimensions of components and features shown in the figures are generally chosen for convenience and clarity of presentation and are not necessarily shown to scale. Many of the figures presented are in the form of schematic illustrations and, as such, certain elements may be drawn greatly simplified or not-to-scale, for illustrative clarity. The figures are not intended to be production drawings. The figures (Figs.) are listed below.

FIG. 1 is a schematic illustration of an element configured to be integrated in a wireless chargeable electrical device functioning as a coil for inductive wireless charging system.

FIG. 2 is a schematic illustration of an element configured to be integrated in a wireless chargeable electrical device functioning as an antenna for RF wireless charging system by the charging case of the present invention.

FIG. 3 is a schematic illustration of an element of the invention connected to a switch that determines its functionality either as a coil for magnetic (inductive) based wireless charging system or as an antenna for electromagnetic (RF) based wireless charging system.

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above described embodiments that would still be covered by the present invention.

### DETAILED DESCRIPTION

The present invention is directed to wireless charging systems which may function as both RF wireless charging systems and inductive wireless charging systems.

In the following description, various aspects of a novel bi-functional receiving element for wireless charging systems will be described. The detailed description is merely exemplary in nature and is in no way intended to limit the scope of the invention, its application, or uses, which may vary. The invention is described with relation to the non-limiting definitions and terminology included herein. These definitions and terminology are not designed to function as a limitation on the scope or practice of the invention, but are presented for illustrative and descriptive purposes only.

Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Furthermore, it should be understood that the disclosure can be carried out or practiced in various ways, and that the disclosure can be implemented in embodiments other than the exemplary ones described herein below.

The descriptions, examples and materials presented in the description, as well as in the claims, should not be construed as limiting, but rather as illustrative. Terms for indicating relative direction or location, such as “right” and “left”, “up” and “down”, “top” and “bottom”, “horizontal” and “vertical”, “higher” and “lower”, and the like, may also be used, without limitation.

It is further to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

The present invention provides for methods of bi-functionally operating a wireless charging system using one or more elements, coupled with a rectifier, which may be configured to operate as an inductive wireless charging system or an RF wireless charging system. It should be appreciated that while embodiments of the present invention incorporate the bi-functional element to be used as a receiving element for a wireless charging system, other embodiments of the invention incorporate the bi-functional element as a transmitting element to act as a primary coil (induction) or a transmitting antenna (RF).

In accordance with embodiments of the invention, an element can function as a secondary coil for receiving energy transmitted by primary coil in a wireless inductive charging system, and also it may function as a receiving antenna (Rx) for receiving RF energy transmitted by transmitting antenna in electromagnetic based wireless charging system. The bi-functional receiving element is configured to be incorporated in a wireless rechargeable device and may switch from functioning as a coil to functioning as an antenna as will be described in detail herein below.

In accordance with other embodiments of the invention, an element can function as a primary coil for transmitting energy to be received by a secondary coil in a wireless inductive charging system, and also it may function as a transmitting antenna for transmitting RF energy to be received by a receiving antenna in electromagnetic based wireless charging system.

In some embodiments, the bi-functional element is configured to be incorporated in a wireless rechargeable device and may switch from functioning as a secondary coil to functioning as a receiving antenna. While in other embodiments, the bi-functional element is configured to be incorporated in a wireless charger to switch from functioning as a primary coil to functioning as a transmitting antenna.

In one main aspect, the present invention is directed to an element that is configured to be incorporated in a receiving unit of a wireless rechargeable electronic device function as a secondary coil for receiving energy transmitted by primary coil in a wireless inductive charging system, and also it may function as a receiving antenna (Rx) for receiving RF energy transmitted by transmitting antenna in electromagnetic based wireless charging system. The bi-functional receiving element is configured to be incorporated in a wireless rechargeable device, and may switch from functioning as a coil when the electrical device is being wirelessly charged by a inductive charger having a primary transmitting coil, to functioning as a receiving antenna when the electrical device is being wirelessly charged by an electromagnetic charger having a transmitting antenna that transmits RF energy.

It should be appreciated that the ability to switch the charging methodology of the device under charge enables vast charging opportunities to the device to be charged without limitation of one wireless charging methodology over the other, and also have economic value as the secondary coil and the receiving antenna share a common component. By having the ability to switch between different charging methodologies, the user may charge his electrical device by any of the two methods without being limited only to one of them. In addition, the manufacturer will not have to choose in a certain methodology for charging the device, as by the same hardware and antenna/coil the rechargeable electrical device will have the ability to be charged in any one of the two wireless charging methodologies and the charging availability will increase.

In a first aspect, a bi-functional element for wireless charging to be integrated in a receiving unit or transmitting unit of a wireless chargeable electrical device is provided. The bi-functional element is configured to function either as a coil for wirelessly charging a device by induction or to function as a RF antenna for wirelessly charging a device by electromagnetic energy. The bi-functional element includes at least one element, said element having at least two electrical contacts at each end of said element, at least two terminals configured to interact with said at least two electrical contact of said element, and at least one rectifier connected to said at least two terminals, wherein said at least two terminal may be open or closed to electrically connect one or more electrical contacts of said at least one element to said rectifier. In this aspect, upon the at least one rectifier forming a closed circuit with said element through closing said at least two terminals, said element serves as a coil providing for inductive wireless charging. Furthermore, in this aspect, upon the at least one rectifier forming an open circuit with said element through opening at least one of said at least two terminals, said element serves as an antenna providing for RF wireless charging.

In such embodiments where the bi-functional element is incorporated in a receiving unit of a rechargeable device, the at least one rectifier forms a closed circuit with said element through closing said at least two terminals, the bi-functional element serves as a secondary coil providing for inductive wireless charging and converts magnetic energy received by the bi-functional element to electrical charge. Upon the at least one rectifier forming an open circuit with said element through opening at least one of said at least two terminals, said receiving element serves as an antenna providing for RF wireless charging and converts RF energy received by the element to an electrical charge.

In such embodiments where the bi-functional element is incorporated in a transmitting unit, the bi-functional element is incorporated in a transmitting unit of a charging device providing wireless charging to rechargeable devices.

In at least one aspect, the bi-functional element further comprises a switch for electrically connecting or disconnecting one or more of said at least two terminals configured to interact with said at least two electrical contact of said element. In aspects using a switch, the switch is controlled by a communication circuit, an energy sensing circuit, an impedance sensing circuit, software or a mobile device software application, or combinations thereof.

The switching between the two charging methodologies is described with reference to the figures below. Reference is now made to the figures.

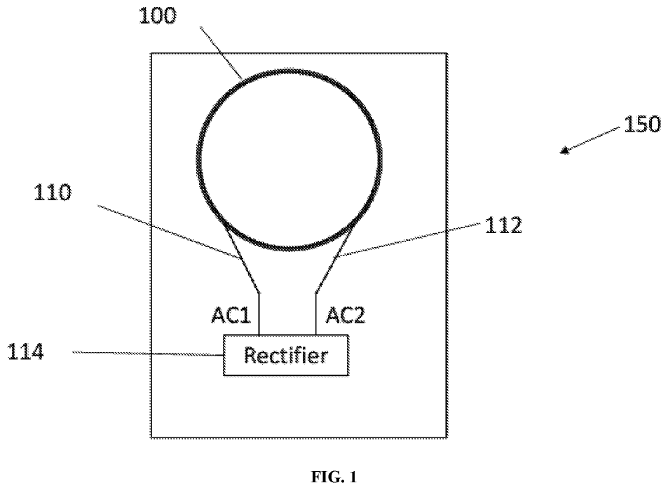

FIG. 1 is a schematic illustration of at least one embodiment of a bi-functional element 100 configured to be integrated in a receiving unit 150 of a wireless chargeable electrical device functioning as a coil for inductive wireless charging system. The element 100 is connected to a rectifier 114 by terminal 110 (AC1) and by terminal 112 (AC2). As a non-limiting example, the configuration of FIG. 1 used in a device to be charged, the element would act as a receiving element to serve as a secondary coil so as to convert the magnetic energy received by the element (acting as a secondary coil) to an electrical charge for charging the device. It should be appreciated that the schematic illustration presented in FIG. 1 may further be incorporated in a wireless charger, or transmitting device, with similar configuration, but for acting as a primary coil for inductive charging of a secondary coil in a receiving unit.

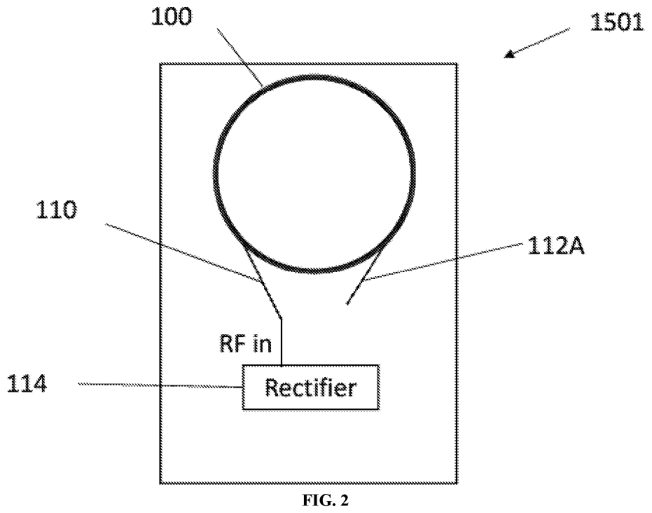

FIG. 2 is a schematic illustration of at least one embodiment of a bi-functional element 100 configured to be integrated in a receiving unit 1501 of a wireless chargeable electrical device functioning as a receiving antenna for RF wireless charging system. As a non-limiting example, the configuration of FIG. 2 used in a device to be charged, the element would act as an antenna 100 and is connected to the rectifier 114 by terminal 110, while the second terminal that was used for induction is now a disconnected terminal 112A, so as to convert the electromagnetic energy received by element (acting as an antenna) to an electrical charge for charging the device. It should be appreciated that the schematic illustration presented in FIG. 2 may further be incorporated in a wireless charger, or transmitting device, with similar configuration, but for transmitting RF energy to a receiving unit.

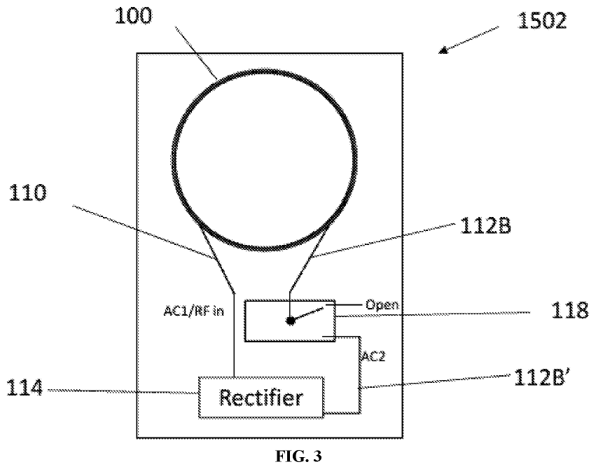

FIG. 3 is a schematic illustration of the receiving element 100 of the invention connected to a switch 118 that determines its functionality within a receiving unit 1502 to function either as a secondary coil for magnetic inductive based wireless charging receiving unit, or as a receiving antenna for electromagnetic (RF) based wireless charging system. In more detail, switch 118 enables the connection or disconnection of terminal 112B′ (AC2) to the rectifier. In a scenario, that only terminal 110 (AC1) is connected to rectifier 114, receiving element 100 functions as a receiving antenna and allows for electromagnetic wireless charging of the electrical device. In such scenario, switch 118 is open and terminal 112B′ (AC2) is detached and not connected to rectifier 114. In a scenario that both terminals are connected to rectifier 114, i.e. switch 118 is close, receiving element 100 serves as a secondary coil and allows for magnetic wireless charging of the electrical device.

In accordance with embodiments of the invention, switch 118 may change its position from an open position (RF charging) to a close position (induction charging), and vice versa, by various triggers. Some non-limiting examples are as follows: (1) The switch is controlled by a communication circuit. In this optional scenario, a signal is received by the switch unit that “informs” in which charging methodology RF or induction, the charging will be performed, and the switch is closed or opened according to the signal received; (2) The switch is controlled by an energy sensing circuit. In this optional embodiment, the sensed energy reaches the receiving unit in a certain power level. Switch 118 will change position and will estimate which of the positions (RF or induction) obtains a higher power and will be set accordingly; (3) The switch is controlled by an impedance sensing circuit. In this optional embodiment, the impedance changes according to the charging environment, induction plate has a specific impedance value while electromagnetic charging device as a different impedance value. The switch will select the proper position according to the impedance value detected at a specific time point; and (4) The switch is control by a dedicated software or mobile application. In this embodiment, the user will be able to select the charger to be used (RF or induction).

In at least one embodiment, a transmitter unit is provided which includes at least one transmitter and at least one bi-functional element. It should be appreciated that the bi-functional element may be configured to be any embodiment of the bi-functional element disclosed herein, including, at least in one embodiment, the use of the rectifier, and in at least one embodiment, a rectifier and switch. Some embodiments involving a transmitter unit, the bi-functional element is coupled to at least one transmitter and operable to cause the at least one bi-functional element to emit electromagnetic radiation. In such embodiments, the bi-functional element may be configured as an antenna for transmitting electromagnetic radiation, or be configured as a primary coil to cause the at least one element to induce magnetic energy to a secondary coil in a receiving unit. In some embodiments, the transmitting unit utilizes either a coil or an antenna, and does not utilize the bi-functional element, or any embodiments thereof, however in such embodiments, the transmitting unit may be coupled with a receiving unit using a bi-functional element.

Thus, in one aspect, the present invention provides for a transmitter unit having at least one transmitter and at least one bi-functional element, as descried anywhere herein, coupled to said at least one transmitter and operable to cause the at least one element to emit electromagnetic radiation when said bi-functional element is configured as an antenna, and operable to cause the at least one element to induce magnetic energy to a secondary coil when said bi-functional element is configured as a primary coil.

In at least one embodiment, a receiver unit is provided which includes at least one bi-functional element. It should be appreciated that the bi-functional element may be configured to be any embodiment of the bi-functional element disclosed herein, including, at least in one embodiment, the use of the rectifier, and in at least one embodiment, a rectifier and switch. Some embodiments involving a receiver unit, the bi-functional element is configured as an antenna to convert RF energy received by the element to an electrical charge or may be configured as a secondary coil to convert magnetic energy received by the element to an electrical charge. The receiving unit further includes a connector for coupling the converted energy received by the bi-functional element to the rechargeable device under charge. In some embodiments, the receiving unit utilizes either a coil or an antenna, and does not utilize the bi-functional element, or any embodiments thereof, however in such embodiments, the receiving unit may be coupled with a transmitting unit using a bi-functional element.

Thus, in another aspect, the present invention provides for a receiver unit having at least one bi-functional element, as described anywhere herein, and operable to cause the at least one element to convert RF energy received by the element to electrical charge when said bi-functional element is configured as an antenna, and operable to cause the at least one element to convert magnetic energy received by the element to electrical charge when said bi-functional element is configured as a secondary coil, and a connector for coupling the converted energy received to the rechargeable device under charge.

In at least one embodiment, a system for bi-functional wireless charging of a rechargeable device is provided which utilizes at least one transmitting unit, at least one receiving unit, and at least one bi-functional element. Each of the transmitting unit, receiving unit or bi-functional element of the system may include any embodiment of a transmitting unit, receiving unit or bi-functional element as herein described.

Thus, one aspect of the present invention provides for a system for bi-functional wireless charging of a rechargeable device, where the system includes at least one transmitting unit having at least one transmitter, at least one receiver unit having at least one receiver and at least one connector for coupling the converted energy received to the rechargeable device under charge, and at least one bi-functional element, as described anywhere herein, coupled to said at least one transmitter or at least one receiver, and operable to cause the at least one element to be configured as an antenna or to be configured as a coil. Operable with the system, the bi-functional element is coupled to at least one receiver in one aspect, is coupled to at least one transmitter in another aspect, or coupled to at least one receiver and at least one transmitter in another aspect.

### Other Embodiments

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

1. A bi-functional element for wireless charging to be integrated in a receiving unit or transmitting unit of a wireless chargeable electrical device, said bi-functional element configured to function either as a coil for wirelessly charging a device by induction or to function as a RF antenna for wirelessly charging a device by electromagnetic energy, said bi-functional element comprising:
at least one element, said element having at least two electrical contacts at each end of said element;
at least two terminals configured to interact with said at least two electrical contact of said element; and
at least one rectifier connected to said at least two terminals, wherein said at least two terminal may be open or closed to electrically connect one or more electrical contacts of said at least one element to said rectifier;
wherein upon the at least one rectifier forming a closed circuit with said element through closing said at least two terminals, said element serves as a coil providing for inductive wireless charging; and
wherein upon the at least one rectifier forming an open circuit with said element through opening at least one of said at least two terminals, said element serves as an antenna providing for RF wireless charging.

2. The bi-functional element of claim 1, wherein said bi-functional element is incorporated in a receiving unit of a rechargeable device, wherein upon the at least one rectifier forming a closed circuit with said element through closing said at least two terminals, said element serves as a secondary coil providing for inductive wireless charging and converts magnetic energy received by the element to electrical charge, and wherein upon the at least one rectifier forming an open circuit with said element through opening at least one of said at least two terminals, said receiving element serves as an antenna providing for RF wireless charging and converts RF energy received by the element to an electrical charge.

3. The bi-functional element of claim 1, wherein said bi-functional element is incorporated in a transmitting unit of a charging device providing wireless charging to rechargeable devices.

4. The bi-functional element of claim 1, further comprising a switch for electrically connecting or disconnecting one or more of said at least two terminals configured to interact with said at least two electrical contact of said element.

5. The bi-functional element of claim 4, wherein the switch is controlled by a communication circuit.

6. The bi-functional element of claim 4, wherein the switch is controlled by an energy sensing circuit.

7. The bi-functional element of claim 4, wherein the switch is controlled by an impedance sensing circuit.

8. The bi-functional element of claim 4, wherein the switch is controlled by software or a mobile device software application.

9. A transmitter unit comprising:
at least one transmitter; and
at least one bi-functional element of claim 1 coupled to said at least one transmitter and operable to cause the at least one element to emit electromagnetic radiation when said bi-functional element is configured as an antenna, and operable to cause the at least one element to induce magnetic energy to a secondary coil when said bi-functional element is configured as a primary coil.

10. A receiver unit comprising:
at least one bi-functional element of claim 1 and operable to cause the at least one element to convert RF energy received by the element to electrical charge when said bifunctional element is configured as an antenna, and operable to cause the at least one element to convert magnetic energy received by the element to electrical charge when said bi-functional element is configured as a secondary coil; and
a connector for coupling the converted energy received to the rechargeable device under charge.

11. A system for bi-functional wireless charging of a rechargeable device, the system comprising:
a transmitting unit having at least one transmitter; and
a receiver unit having at least one receiver and at least one connector for coupling the converted energy received to the rechargeable device under charge; and at least one bi-functional element of claim 1 coupled to said at least one transmitter or at least one receiver, and operable to cause the at least one element to be configured as an antenna or to be configured as a coil.

12. The system of claim 11 wherein the bi-functional element is coupled to at least one receiver.

13. The system of claim 11 wherein the bi-functional element is coupled to at least one transmitter.
